(19) United States
(12) Patent Application Publication
(10) Pub. No.: US 2016/0332373 A1
(43) Pub. Date: Nov. 17, 2016

(54) Methods and Systems for Three-Dimensional Printing Utilizing Multiple Binder Fluids

(71) Applicant: THE EXONE COMPANY, North Huntingdon, PA (US)

(72) Inventors: Howard A. Kuhn, Butler, PA (US); Jason W. Plymire, Belle Vernon, PA (US); Rick D. Lucas, Belmont, OH (US); Jesse M. Blacker, St. Clairsville, PA (US); Daniel T. Brunermer, Leechburg, PA (US); Thomas Lizzi, Harmony, PA (US)

(73) Assignee: The ExOne Company, North Huntington, PA (US)

(21) Appl. No.: 15/107,537

(22) PCT Filed: Dec. 17, 2014
(86) PCT No.: PCT/US2014/070743

§ 371 Date: Jun. 23, 2016

Related U.S. Application Data
(60) Provisional application No. 61/919,961, filed on Dec. 23, 2013.
(60) Provisional application No. 61/919,883, filed on Dec. 23, 2013.

(51) Int. Cl. B29C 67/00; B33Y 30/00; B33Y 50/02; B33Y 10/00

(52) U.S. Cl. CPC B29C 67/0081; B29C 67/0088; B29C 67/0092; B33Y 10/00; B33Y 30/00; B33Y 50/02; B29K 2105/251

(57) ABSTRACT

Methods and systems (2) are disclosed for making articles (114) by three-dimensional printing. The methods include selectively printing by jet deposition on successive layers (4) of a build material powder (10) at least one of a first binder fluid and a second binder fluid. At least one of the first and second binder fluids includes a particulate matter (16) having mean particle size diameter which is less than that of the build material powder (10). The first binder fluid is characteristically different from the second binder fluid. The particulate matter (16) selectively deposited with a binder fluid can be used to locally tailor the physical properties of the article (114), e.g. by alloying with the build material powder, increasing densification, acting as a local infiltrant or infiltrant stop during heat treatment, locally modulating the local stress fields (e.g. by a mismatch of thermal coefficients of expansion), etc. Among the possible locally tailored properties is the surface finish of an interior or exterior surface of the article (114).

### RELATED APPLICATIONS

This patent application claims priority to U.S. Provisional Application Ser. No. 61/919,883, filed Dec. 23, 2013, and to U.S. Provisional Application Ser. No. 61/91,919,961, filed Dec. 23, 2013 and incorporates both of those provisional applications by reference in their entireties.

### BACKGROUND

1. Field of the Invention

The invention relates to methods for producing articles by three-dimensional printing.

2. Background of the Invention

Three dimensional printing was developed in the 1990's at the Massachusetts Institute of Technology and is described in several United States patents, including the following U.S. Pat. No. 5,490,882 to Sachs et al., U.S. Pat. No. 5,490,962 to Cima et al., U.S. Pat. No. 5,518,680 to Cima et al., U.S. Pat. No. 5,660,621 to Bredt et al., U.S. Pat. No. 5,775,402 to Sachs et al., U.S. Pat. No. 5,807,437 to Sachs et al., U.S. Pat. No. 5,814,161 to Sachs et al., U.S. Pat. No. 5,851,465 to Bredt, U.S. Pat. No. 5,869,170 to Cima et al., U.S. Pat. No. 5,940,674 to Sachs et al., U.S. Pat. No. 6,036,777 to Sachs et al., U.S. Pat. No. 6,070,973 to Sachs et al., U.S. Pat. No. 6,109,332 to Sachs et al., U.S. Pat. No. 6,112,804 to Sachs et al., U.S. Pat. No. 6,139,574 to Vacanti et al., U.S. Pat. No. 6,146,567 to Sachs et al., U.S. Pat. No. 6,176,874 to Vacanti et al., U.S. Pat. No. 6,197,575 to Griffith et al., U.S. Pat. No. 6,280,771 to Monkhouse et al., U.S. Pat. No. 6,354,361 to Sachs et al., U.S. Pat. No. 6,397,722 to Sachs et al., U.S. Pat. No. 6,454,811 to Sherwood et al., U.S. Pat. No. 6,471,992 to Yoo et al., U.S. Pat. No. 6,508,980 to Sachs et al., U.S. Pat. No. 6,514,518 to Monkhouse et al., U.S. Pat. No. 6,530,958 to Cima et al., U.S. Pat. No. 6,596,224 to Sachs et al., U.S. Pat. No. 6,629,559 to Sachs et al., U.S. Pat. No. 6,945,638 to Teung et al., U.S. Pat. No. 7,077,334 to Sachs et al., U.S. Pat. No. 7,250,134 to Sachs et al., U.S. Pat. No. 7,276,252 to Payumo et al., U.S. Pat. No. 7,300,668 to Pryce et al., U.S. Pat. No. 7,815,826 to Serdy et al., U.S. Pat. No. 7,820,201 to Pryce et al., U.S. Pat. No. 7,875,290 to Payumo et al., U.S. Pat. No. 7,931,914 to Pryce et al., U.S. Pat. No. 8,088,415 to Wang et al., U.S. Pat. No. 8,211,226 to Bredt et al., and U.S. Pat. No. 8,465,777 to Wang et al.

In essence, three-dimensional printing involves the spreading of a layer of particulate material and then selectively jet-printing a fluid onto that layer to cause selected portions of the particulate layer to bind together. This sequence is repeated for additional layers until the desired part has been constructed. The material making up the particulate layer is often referred as the “build material” or “the build material powder” and the jetted fluid is often referred to as a “binder”, or in some cases, an “activator”. Post-processing of the three-dimensionally printed part is often required in order to strengthen and/or densify the part.

Various methods are used to supply each new powder layer for three-dimensional printing. For example, some three-dimensional printers have a powder reservoir box which contains powder supported upon a vertically indexable platform and use a counter-rotating roller to transfer a predetermined amount of powder from the top of the powder reservoir box to the top of a build box. Some other three-dimensional printers utilize a traveling dispenser to dispense each new layer of powder.

Despite its advantages, conventional three-dimensional printing processes have their drawbacks. One such drawback is that the surface of the resulting article has a contour resolution that is on the order of the particle layer thickness used during the three-dimensional printing process. Typically, the particle layer thickness is in the range of 50 to 500 microns.

Another drawback is that the apparent density of the printed part is essentially the same as the packing density the powder bed that is created during the three-dimensional printing process. Such densities often are in the range of about 50 to 60% which requires a significant amount of material to be added if infiltration is to be used to densify the article. In cases where densification is to be achieved by sintering or thermomechanical processing, the low print density requires there to be a large amount of shrinkage to densify the article thus increasing the chances of the occurrence of geometrical distortion.

Another drawback is the inability to locally tailor the properties of the article since all areas receive the same binder fluid jet-deposited upon the same build material powder.

### SUMMARY OF THE PRESENT INVENTION

In one aspect, the present invention provides methods of producing dense three-dimensionally printed articles in manners which overcome the aforementioned disadvantages of the prior art. The methods of the present invention modify the three-dimensional printing process such that the binder fluid that is selectively deposited onto the powder layers contains particulate matter that is smaller than the mean particle size of the build material powder. Preferably, this jet-deposited particulate matter has a mean particle size that is greater than about 1 micron and less than or equal to 50 microns. The jet-deposited particulate matter may be compositionally the same as or different from the build material powder. The jet-deposited material acts to fill in the interparticle interstices of the build material powder thereby simultaneously increasing the density of the printed article and improving its surface roughness and contour resolution, which in turn, improves the surface finish of the final article.

In another aspect, the present invention provides three-dimensional printing systems which have the ability to selectively deposit on the build material powder layers a binder fluid which contains particulate matter that is smaller than the mean particle size of the build material powder.

In yet another aspect, the present invention provides three-dimensional printing systems which comprise a first print head system that is adapted to selectively deposit a first binder fluid and a second print head system that is adapted to selectively deposit a second binder fluid. Each of the first and second print fluid handling systems includes a binder fluid supply and a print head. At least one of the first and second print fluid handling systems is adapted to jet-deposit a binder fluid which contains particulate matter has a mean particle size diameter that is smaller than the mean particle size of the build material powder.

In another aspect, the present invention provides methods for three-dimensionally printing articles in which selected portions of the article are printed by a first print fluid handling system and other selected portions of the article are printed by a second print fluid handling system wherein at least one of the first and second print fluid handling systems is adapted to jet deposit a binder fluid which contains particulate matter has a mean particle size diameter that is smaller than the mean particle size of the build material powder.

### BRIEF DESCRIPTION OF THE DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is schematic drawing of a step of selectively jet-depositing a particle-bearing binder fluid upon a layer of build powder in accordance with an embodiment of the present invention.

FIG. 2 is a schematic drawing of a three-dimensional printing system according to an embodiment the present invention.

FIG. 3 is a schematic of a three-dimensional printing system according to an embodiment of the present invention having a first print head system and a second print head system.

FIG. 4 is a schematic depiction of a print layer upon which two different binder fluids were selectively deposited in portions of three different articles in accordance with an embodiment of the present invention.

FIG. 5 is a schematic depiction of a print layer upon which two different binder fluids were selectively deposited in portions of two different articles each having an internal feature in accordance with an embodiment of the present invention.

FIG. 6 is a schematic depiction of a print layer upon which five different binder fluids were selectively deposited in portions of an article having an internal feature in accordance with an embodiment of the present invention.

FIG. 7 is a schematic depiction of a print layer upon which two different binder fluids were selectively deposited in portions of an article, including a portion in which both binder fluids were deposited, in accordance with an embodiment of the present invention.

FIG. 8 is a schematic depiction of a binder handling system according to an embodiment of the present invention.

### DESCRIPTION OF PREFERRED EMBODIMENTS

In this section, some preferred embodiments of the present invention are described in detail sufficient for one skilled in the art to practice the present invention without undue experimentation. It is to be understood, however, that the fact that a limited number of preferred embodiments are described herein does not in any way limit the scope of the present invention as set forth in the appended claims. It is to be understood that whenever a range of values is described herein or in the appended claims that the range includes the end points and every point therebetween as if each and every such point had been expressly described. Unless otherwise stated, the word “about” as used herein and in the appended claims is to be construed as meaning the normal measuring and/or fabrication limitations related to the value which the word “about” modifies. Unless expressly stated otherwise, the term “embodiment” is used herein to mean an embodiment of the present invention.

The methods of the present invention comprise three-dimensionally printing articles by selectively jet-depositing a particle-bearing binder fluid upon successive layers of a build material powder such that the particles of the fluid increase the apparent density of the as-printed article. As those skilled in the art will recognize, apparent density refers to the density that a porous article has compared to the density which the article would have if its pores were eliminated. The particulate matter of the fluid is smaller than the mean particle size of the build material powder. Preferably, this jet-deposited particulate matter has a mean particle size that is in the size range of about 1 to 50 microns. The jet-deposited material acts to fill in the interparticle interstices of the build material powder thereby simultaneously increasing the density of the printed article and improving its surface roughness and contour resolution, which in turn, improves the surface finish of the final article.

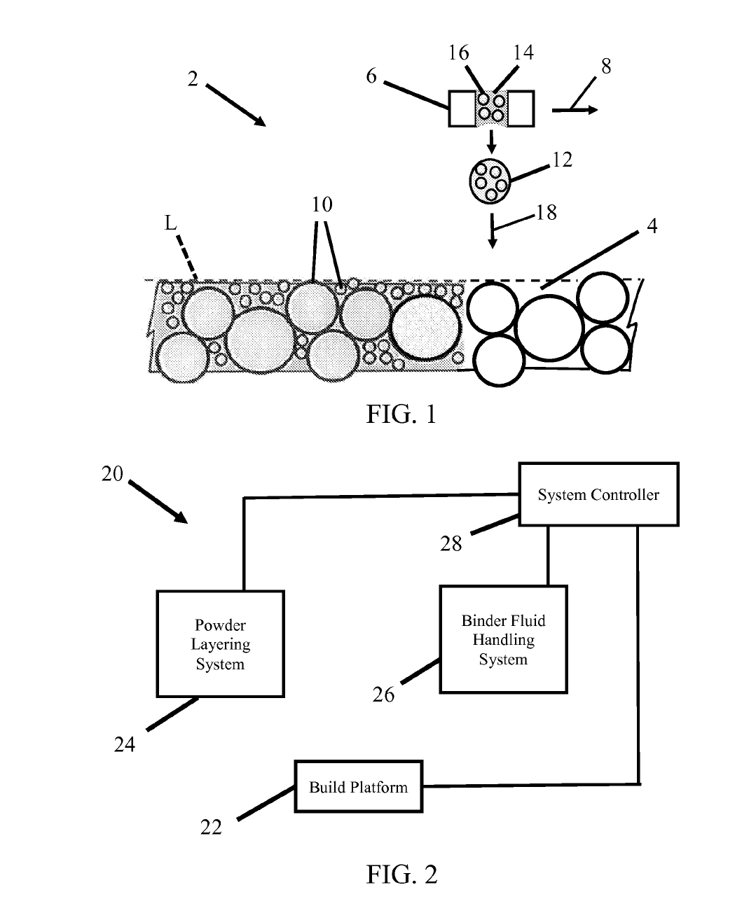

FIG. 1 shows a schematic representation of a portion of a three-dimensional printing system 2 performing a step of a three-dimensional printing method in accordance with the present invention. The system 2 includes a powder layer 4 that is the top layer of a powder bed in which an article is being built and a print nozzle 6 which is moving relative to the powder layer 4 in the direction indicated by arrow 8. The powder layer 4 comprises particles of the build material powder 10, which have a mean particle size diameter of D₁. As the nozzle 6 moves along, it jets droplets, e.g. droplet 12, of a binder fluid 14 containing particulate matter 16 in the direction of arrow 18 so that they impinge the powder layer 4. As the droplets impinge the powder layer 4, the binder fluid 14 they contain spreads out into the powder layer 4 (as indicated by the grey shading in the left-hand side of the powder layer 4) as does the particulate matter 16 they contain. Note that the particulate matter 16 has a mean particle size diameter of D₂ which is smaller than D₁. The presence of the particulate matter 16 helps to smooth the surface of the powder layer 4 as is evident by comparing the left side of the powder layer 4 into which the particulate-bearing binder fluid 14 has been jetted and the right hand side of the powder layer 4 which has not yet received any of the binder fluid 14 with the dotted reference line L.

The build material powder may be any desired particulate matter that is compatible with the three-dimensional printing process and the binder fluid that is to be used and the article that is to be built. The build material powder may be a metal, metal alloy, ceramic, form of carbon (e.g., graphite, coke, carbon black, etc.), or polymer, or any combination thereof. The build material powder may comprise particles of one material which are coated with another, e.g. tungsten particles coated with copper or sand particles coated with resin. The build material powder may have any particle size that is compatible with the three-dimensional printing process. Preferably, the build material powder has a mean particle size diameter in the range of about 10 to about 500 microns, and more preferably in the range of about 15 to about 300 microns, and even more preferably in the range of about 20 to about 200 microns. It is to be understood that the actual particle size distribution of a build material powder will include particle sizes both above and below the mean particle size diameter.

The jetted-particulate matter may be any desired particulate matter that is compatible with the binder fluid and being suspended within the binder fluid for serviceable times. The jetted-particulate matter is to be chosen to yield the desired properties in combination with the build material powder material during the processing of the article from the three-dimensional printing stage through any heat treatments and finishing operations. The jetted-particulate matter may be chosen to be compositionally the same as or similar to or different from the build material powder. It may be chosen to alloy with or otherwise react with or interact with (e.g. by creating a stress field) the build material powder material during the processing of the article from the three-dimensional printing stage through any heat treatments and finishing operations. The jetted-particulate matter is chosen to have a particle size distribution that will avoid blockage in any portion of the binder handling system portion of the three-dimensional printer, especially the orifices and passageways in portions of the print heads. Preferably, the mean particle size diameter of the jetted-particulate matter is greater than about 1 micron and no more than about 50 microns, but it may be greater than 50 microns, provided that the binder fluid handling system is adapted to accommodate the particle size without blockages that would make the jetting impractical. In some embodiments, the mean particle size diameter of the jetted-particulate matter may be less than 1 micron, even down to 1 nanometer. More preferably, the mean particle size diameter of the jetted-particulate matter is in the range of about 2 microns to about 20 microns, and even more preferably in the range of about 2 microns to about 10 microns. In some embodiments, it is preferred that the mean particle size diameter of the jetted-particulate matter is less than about 5 microns. It is also desirable to select the mean particle size diameter of the jetted-particulate matter so that it is about one seventh or less than that of the build material powder. It is to be understood that the actual particle size distribution of a jetted-particulate matter will include particle sizes both above and below the mean particle size diameter.

The binder fluid may be any binder fluid that is compatible with the three-dimensional printing system and the build material powder that are being used to make the desired article. The binder fluid is to include a binder, i.e. a component that acts to bind together the build material powder particles by means other than liquid surface tension, e.g. a polymer, and carrier fluid, which is sometimes referred to as a “solvent” whether or not it actually dissolves anything of relevance to the operation. The binder fluid may also include one or more agents which either alone or in concert adjust one or more of the surface tension, evaporation rate, and the viscosity of the binder fluid. The binder fluid preferably also includes an agent which aids in the suspension of the jetted-particulate matter.

To aid the jetted-particulate matter from settling out of the binder fluid, the binder fluid handling system of the three-dimensional printing system may be provided with a means for mixing the jetted-particulate matter and the binder fluid. For example, in-line mixers may be used in one or more of the system's conduits; one or more binder fluid reservoirs may be provided with spinning mixing blades; sub-sonic, sonic, or ultrasonic vibrations may be applied to the mixing fluid; a recirculation system may be included to recirculate the binder fluid at speeds that avoid particulate settling; or any combination of the foregoing may be included.

The loading of binder fluid with the jetted-particulate matter is to be selected based on several factors. These include, the amount of jetted-particulate matter that is desired to be deposited for a predetermined print head traverse speed and droplet size, with higher deposited amounts requiring higher levels of particulate-loading. Another factor is particulate-loading must be controlled so as to stay within the range of viscosities that the print head system is capable of handling. Another factor is that the particulate-loading (along with droplet size) must be controlled so as prevent the momentum transfer that occurs upon the impact of the droplet with the powder layer from causing unwanted disruptions to the powder layer. Another factor is the effect the particulate-loading might have on the evaporation rate of the binder fluid's carrier fluid and this is to be controlled so that the carrier fluid evaporation occurs at a sufficiently high rate so as to permit the three-dimensional printing process to proceed without the deposition of a succeeding powder layer from disrupting its underlying printed layer. Another factor is that the particulate-loading must be not be so high as to cause blockage of the binder fluid handling system by way of accretion or settling out of portions of the jetted-particulate matter. Of high importance is keeping the particulate-loading sufficiently low so as to permit the controlled formation of the desired-sized jetted binder fluid droplets. Preferably, the particulate-loading is such that the volume percent of the jetted-particulate matter of the binder fluid is in the range of about 1 to about 20%.

The present invention also includes three-dimensional printing systems which are adapted to selectively deposit on build material powder layers a binder fluid which contains particulate matter having a mean particle size diameter that is smaller than the mean particle size diameter of the build material powder. As schematically depicted in FIG. 2, such a system 20 includes a build platform 22 adapted to receive successive layers of a build material powder, a powder layering system 24 adapted to apply successive layers of the build material powder to the build platform 22, a binder fluid handling system 26 adapted to selectively jet binder fluid onto the successive powder layers, and a control system 28 which is adapted to provide the overall control of the system 20. The build platforms and powder layering systems described in the prior art may be included into embodiments of the inventive system.

The binder handling systems of the inventive three-dimensional printing systems must be adapted to utilize the particle-laden binder fluids described above without blockages that would make system operation impractical. To accomplish this, the orifice sizes and fluid flow rates through the orifices and fluid conduits of such binder handling systems must be selected to prevent blockage by accretion or settling out of particulates of the jetted-particulate matter. Preferably, the binder handling systems, e.g. binder handling system 126 shown in FIG. 8, include a mechanically-stirred binder fluid reservoir, e.g. mechanically-stirred binder fluid reservoir 132. It is also preferred to include one or more in-line mixing elements, e.g. in-line mixer 134, in one or more transfer lines, e.g. transfer line 136 of the binder handling system, these mixers being sized to accommodate the flow rates and particle sizes being used. It is also preferred to use a recirculation system, e.g. recirculation system 138, comprising a pump, e.g. pump 140, and transfer lines into and out of the binder fluid reservoir, e.g, transfer lines 142, 144, 146, to recirculate the binder fluid so as to discourage particulate settling.

It is also preferred that the binder handling system include a print head 148 through which the binder fluid may be recirculated to the binder fluid reservoir. Preferably, such a print head will utilize a design having a common local reservoir for a plurality of printing orifices, such as is described in U.S. Application Publication No. US 2012/0274686 A1 published on Nov. 1, 2012.

The control systems of the prior art may be utilized with the embodiments so long as they are modified to operate the chosen binder handling system.

It is to be understood that all of the components of the binder handling system which come into contact with the binder fluid should be made of wear resistant materials. The selection of the degree of wear resistance for such materials will be affected by the expected types of jetted-particulate matters and binder fluid flow rates that are to utilized during the operation of the binder fluid system as well as the amount of use the binder handling fluid system that is expected. The selection of components with high wear resistance will be beneficial where the jetted-particulate matters are abrasive or the binder fluid flow rates are high or the binder fluid system is expected to be heavily used.

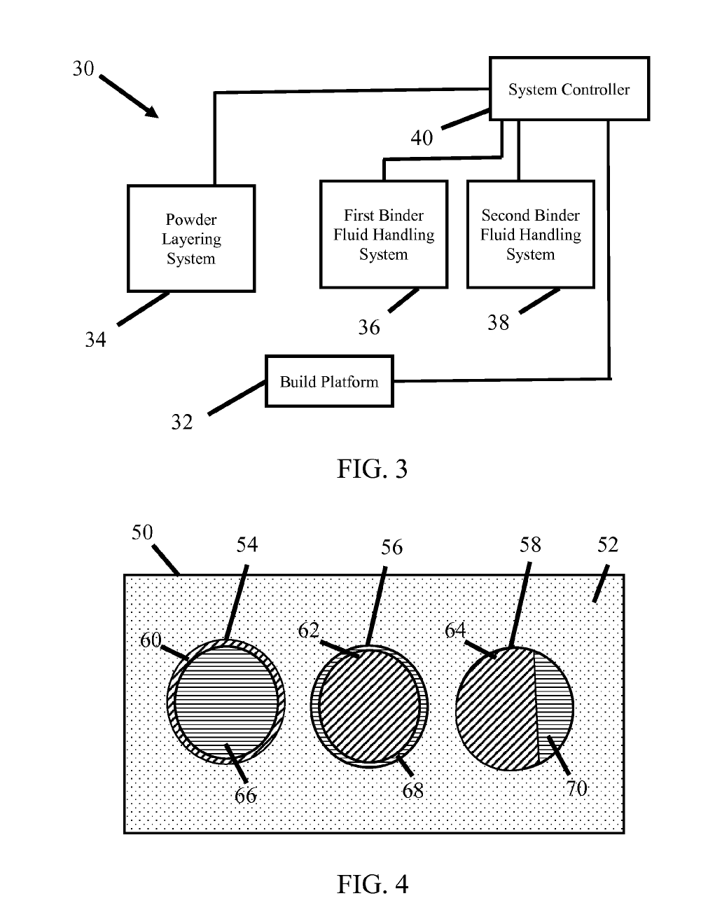

The present invention also includes three-dimensional printing systems as described above except that they comprise a plurality of print fluid handling systems in which at least one of the print fluid handling systems is adapted to jet deposit a binder fluid which contains a particulate matter as described above. FIG. 3 schematically depicts such a system as three-dimensional printing system 30. System 30 includes a build platform 32, a powder layering system 34, a first binder fluid handling system 36, a second binder fluid handling system 38, and a system controller 40 which is adapted to provide the overall control of the system. Each of the first and second binder fluid handling systems 36, 38 includes a source of a binder fluid and a print head adapted to selectively jet-deposit that binder fluid. Each of the first and second binder fluid handling systems 36, 38 may have its own carriage device for positioning its respective print head to selectively jet deposit its respective first or second binder fluid, though, preferably, the first and second binder fluid handling systems 36, 38 share all or portions of a common carriage device. For example, the respective print heads of the first and second binder fluid handling systems 36, 38 may be carried by a common or separate trolleys in one direction, e.g. the x-direction, and ride on a common or separate trolleys in another direction, e.g. the y-direction.

A three-dimensional printing system 30 may be configured so that both of the first and second binder fluid handling systems 36, 38 may utilize a binder fluid which contains particulate matter as described above. In such a three-dimensional printing system 30, one or more characteristics of the respective binder fluids of the first and second binder fluid handling systems 36, 38 are different so that it is necessary to utilize two separate binder handling systems. Such characteristics can relate to the particulate matter, e.g. material composition, mean particle size diameter, particle size distribution, particle morphology, etc., or to the non-particulate matter characteristics of the binder fluid, e.g. the composition or amounts of one or more of the binder and the carrier fluid, and the composition or amounts of any of the various agents for controlling, either alone or in concert, the surface tension, evaporation rate, viscosity, and the particulate suspension capability of the binder fluid.

In some preferred embodiments, the binder fluid utilized by the first binder fluid handling system is similar to that utilized by the second binder fluid handling system except that the latter binder fluid contains particulate matter while the former binder fluid does not.

It is to be understood that while only a first and a second binder fluid handling systems are described with relation to FIG. 3, the present invention includes embodiments having more than just two binder fluid handling systems, wherein at least two of the binder handling systems utilize binder fluids that are different from one another and at least one of the binder fluids includes the particulate matter as described above.

The present invention also includes methods of three-dimensionally printing articles which utilize a three-dimensional printing system which comprises a first print fluid handling system and a second print fluid handling system in which at least one of the first and second print fluid handling systems is adapted to jet a binder fluid which contains a particulate matter as described above. Such methods include selectively printing a first print fluid in some locations and selectively printing a second print fluid in other locations within article or in locations which overlap in part or in whole the locations in which the first print fluid was printed. Some illustrative embodiments of such methods will now be discussed. It should be kept in mind when reading through these embodiments that the selective deposition of a binder fluid containing particulate matter at an exterior or interior surface of an article has the effect of improving the article's surface finish. It is also be to be kept in mind that the particulate matter selectively deposited with a binder fluid can be used to locally tailor the physical properties of the article, e.g. by alloying with the build material powder, increasing densification, acting as a local infiltrant or infiltrant barrier during heat treatment, locally modulating the local stress fields (e.g. by a mismatch of thermal coefficients of expansion), etc.

Referring to FIG. 4, there is schematically shown a layer 50 of a build material powder 52 (indicated by a field of small dots) which has been spread during the building of three articles, first article 54, second article 56, and third article 58, by three-dimensional printing in accordance with a method embodiment. A first print handling system using a first binder fluid was employed to print and the areas in which this first binder fluid was selectively printed, areas 60, 62, 64, are indicated by diagonal hatching. A second print handling system using a second binder fluid was employed to print and the areas in which this second binder fluid was selectively printed, areas 66, 68, 70, are indicated by horizontal hatching. The second binder contained a particulate matter as described above. For the portion of layer 50 which was used to print a slice of first article 54, the peripheral area 60 of this slice was printed using the first binder and the interior area 66 was printed using the second binder. For the portion of layer 50 which was used to print a slice of second article 56, the interior area 62 of this slice was printed using the first binder and the peripheral area 68 was printed using the second binder. For the portion of layer 50 which was used to print a slice of third article 58, the left-side area 64 of this slice was printed using the first binder and the right-side area 70 was printed using the second binder.

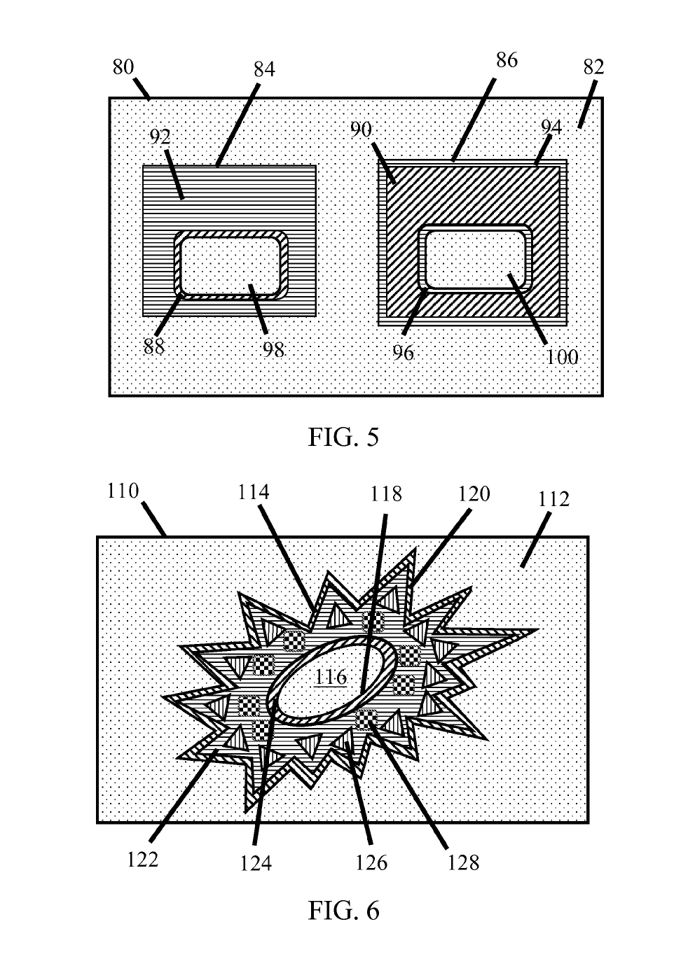

Referring to FIG. 5, there is schematically shown a layer 80 of a build material powder 82 (indicated by a field of small dots) which has been spread during the building of two articles, fourth article 84 and fifth article 86, by three-dimensional printing in accordance with a method embodiment. A first print handling system using a first binder fluid was employed to print and the areas in which this first binder fluid was selectively printed, areas 88, 90, are indicated by diagonal hatching. A second print handling system using a second binder fluid was employed to print and the areas in which this second binder fluid was selectively printed, areas 92, 94, 96, are indicated by horizontal hatching. The second binder contained a particulate matter as described above. Each of the fourth and fifth articles 84, 86, have in their respective slices an unprinted internal feature, e.g. a passageway, internal features 98, 100 respectively. For the portion of layer 80 which was used to print a slice of fourth article 84, the area 88 of this slice around the periphery of the internal feature 98 was printed using the first binder and the major area 92 was printed using the second binder. For the portion of layer 80 which was used to print a slice of fifth article 86, the interior area 90 of this slice was printed using the first binder and the peripheral area 94 as well as the periphery 96 of the internal feature 100 were printed using the second binder.

Referring to FIG. 6, there is schematically shown a layer 110 of a build material powder 112 (indicated by a field of small dots) which has been spread during the building of a single article, sixth article 114, by three-dimensional printing in accordance with a method embodiment. The slice of the sixth article 114 that is in layer 110 has an unprinted internal feature 116, which could be a passageway, having an internal surface 118. In this embodiment, five different binding fluid handling systems were employed. A first binder fluid was deposited in the areas 120 as indicated by diagonal hashing which slants downwardly left-to-right. A second binder fluid was deposited in the areas 122 as indicated by horizontal hashing. A third binder fluid was deposited in the areas 124 as indicated by diagonal hashing which slants upwardly left-to-right. A fourth binder fluid was deposited in the areas 126 as indicated by vertical hashing. A fifth binder fluid was deposited in the areas 128 as indicated by checkerboard hashing. The characteristics of these binder fluids are given in Table 1 below:

TABLE 1

| | | | | Particulate |
|---|---|---|---|---|
| | | Carrier | Particulate | Matter Mean |
| Identification | Binder Type | Fluid Type | Matter Type | Size Diameter |
| First | Polymer A | Fluid A | Alloy A | 20 Microns |
| binder fluid | | | | |
| Second | Polymer A | Fluid A | None | Not |
| binder fluid | | | | applicable |
| Third | Polymer A | Fluid A | Alloy A | 10 microns |
| binder fluid | | | | |
| Fourth | Polymer B | Fluid B | Alloy A | 20 microns |
| binder fluid | | | | |
| Fifth | Polymer A | Fluid A | Alloy B | 5 microns |
| binder fluid | | | | |

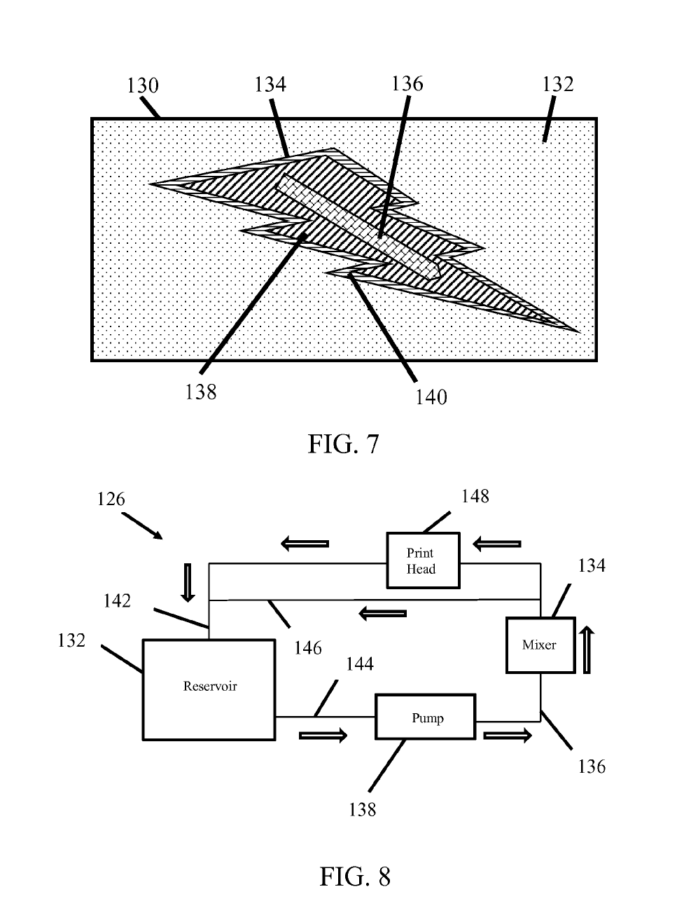

Referring to FIG. 7, there is schematically shown a layer 130 of a build material powder 132 (indicated by a field of small dots) which has been spread during the building of a single article, seventh article 134, by three-dimensional printing in accordance with a method embodiment. This embodiment illustrates the use of overlap printing of two binder fluids in area 136 as indicated by brick-pattern hatching. A first print handling system was used to print a first binder fluid in the overlap area 136 as well as in area 138, which is indicated by diagonal hatching. A second print handling system was used to print a second binder fluid in the overlap area 136 as well as in area 140, which is indicated by horizontal hatching.

Although the overlap area 136 is shown in FIG. 7 as being within the interior portion seventh article 134, in some embodiments, it is preferred to have an overlap area that includes an inner or outer surface of the article that is being three-dimensionally printed. This is especially preferred when each of the binder fluids being deposited includes a particulate matter so that the combined deposition of these particulate matters provides a benefit with regard to one or more of surface finish, density, or the composition of the surface.

While only a few embodiments of the present invention have been shown and described, it will be obvious to those skilled in the art that many changes and modifications may be made thereunto without departing from the spirit and scope of the invention as described in the following claims. All United States patents and patent applications, all foreign patents and patent applications, and all other documents identified herein are incorporated herein by reference as if set forth in full herein to the full extent permitted under the law.

What is claimed is:

1-21. (canceled)

22. A method for three-dimensionally printing an article (114) comprising the steps of:
(a) forming a layer (4) of a build material powder (10), the build material powder (10) having a first mean particle size diameter;
(b) selectively printing by jet deposition on the layer (4) at least one of a first binder fluid and a second binder fluid, wherein at least one of the first and second binder fluids contains a particulate matter (16) having a second mean particle size diameter which is less than the first mean particle size diameter and is at least 0.5 microns and the first binder fluid is characteristically different from the second binder fluid; and
(c) repeating steps (a) and (b) until the article is formed;
wherein during at least one of the instances of performing step (b), the selective printing deposits the particulate matter (16) on the then-current layer, and wherein the first binder fluid is deposited on the then-current layer in at least one of the instances of performing step (b), and wherein the second binder fluid is deposited on the then-current layer in at least one of the instances of performing step (b).

23. The method of claim 22, wherein at least one of the first and second binder fluids has a binder loading with the particulate matter (16) in the range of between 1 and 20 volume percent.

24. The method of claim 22, wherein the particulate matter (16) is a first particulate matter and the first binder fluid includes the first particulate matter and the article (114) has a surface and a first region (120) including the surface, the method including the step of performing steps (b) and (c) so as to selectively print the first binder fluid in the first region (120).

25. The method of claim 24, wherein the surface is that of an interior feature (116) of the article (114).

26. The method of claim 24, wherein the article has a second region (122) adjacent to the first region (120), the method including the step of performing steps (b) and (c) so as to selectively print the second binder fluid in the second region (122).

27. The method of claim 22, wherein the particulate matter (16) is a first particulate matter and the first binder fluid includes the first particulate matter.

28. The method of claim 27, wherein the second binder fluid contains a second particulate matter, the second particulate matter being compositionally the same as or different from the first particulate matter of the first binder fluid.

29. The method of claim 27, wherein the first particulate matter has a mean particle size diameter that is greater than that of the second particulate matter.

30. The method of claim 22, wherein the particulate matter (16) has a mean particle size diameter which is no greater than 50 microns.

31. The method of claim 22, wherein the particulate matter (16) has a mean particle size that is in the range of 1 to 20 microns.

32. The method of claim 22, the method including the step of performing steps (b) and (c) so as to selectively print the first and second binder fluids in a common region (136) of the article (134).

33. The method of claim 32, wherein the common region (136) is near a surface of the article (134).

34. A system (30) for three-dimensionally printing an article (114) from a build material powder, the system comprising:
a build platform (32) adapted to receive the build material powder (10) having a first mean particle size diameter;
a powder layering system (34) adapted to apply successive layers (4) of the build material powder (10) onto the build platform (32);
a first binder fluid handling system (36) adapted to selectively print by jet deposition a first binder fluid, the first binder fluid handling system (36) having a first print head adapted to jet deposit the first binder fluid onto one or more layers (4) of the successive layers of the build material powder (10);
a second binder fluid handling system (38) adapted to selectively print by jet deposition a second binder fluid, the second binder fluid handling system (38) having a second print head adapted to jet deposit the second binder fluid onto one or more layers of the successive layers (4) of the build material powder (10);
a control system (40) adapted to control the three-dimensional printing system (30);
wherein at least one of the first and second binder fluids contains a particulate matter (16) having a second mean particle diameter and the second mean particle size diameter is less than the first mean particle size diameter and is at least 0.5 microns and the first binder fluid is characteristically different from the second binder fluid.

35. The system (30) of claim 34, wherein at least one of the first and second binder handling systems (36, 38) includes an in-line mixer adapted to suspend the particulate matter (16) in its respective first or second binder fluid.

36. The system (30) of claim 34, wherein at least one of the first and second binder handling systems (36, 38) includes a binder fluid recirculation system comprising a pump and transfer lines.

37. The system (30) of claim 36, wherein the binder fluid recirculation system is adapted to recirculate the respective first or second binder fluid through the respective first or second print head.

38. The system (30) of claim 34, wherein the first and second binder fluid handling systems share at least a portion of a carrier device.

39. The system (30) of claim 34, wherein at least one of the first and second print heads includes a plurality of print nozzles and a common reservoir shared by the plurality of print nozzles.

40. The system (30) of claim 34, wherein the particulate matter (16) has a mean particle size diameter which is no greater than 50 microns.

41. The system (30) of claim 34, wherein the particulate matter (16) has a mean particle size diameter which is in the range of 1 to 20 microns.

42. The system (30) of claim 34, wherein the particulate matter (16) has a mean particle size diameter which is less than 5 microns.
